(19) United States
(12) Patent Application Publication
(10) Pub. No.: US 2020/0284903 A1
(43) Pub. Date: Sep. 10, 2020

(54) METHOD FOR TRACKING UNDERWATER OBJECTS

(71) Applicant: SUBSEA FINDER LLC, Lafayette, IN (US)

(72) Inventors: Juergen ZACH, West Lafayette, IN (US); Arsham SHIRKHANI, Redwood City, CA (US)

(21) Appl. No.: 16/646,592

(22) PCT Filed: Sep. 12, 2018
(86) PCT No.: PCT/US18/50777

§ 371 Date: Mar. 12, 2020

Related U.S. Application Data
(60) Provisional application No. 62/557,154, filed on Sep. 12, 2017.
(60) Provisional application No. 62/557,156, filed on Sep. 12, 2017.

(51) Int. Cl. G01S 15/93; G01S 15/46; G01S 5/24; G01S 7/523; G01S 7/56

(52) U.S. Cl. CPC G01S 15/93; G01S 15/46; G01S 5/24; G01S 2205/04; G01S 7/56; G01S 2015/465; G01S 7/523

(57) ABSTRACT

An underwater remote locator device for tracking and positioning an object of the present disclosure can include a remote transducer system, abase transducer system, and a navigation module. The remote transducer system can be coupled to an object desired to be tracked. The remote transducer system can include a power source, processing means, acoustic receiver, and an acoustic transmitter. The acoustic transmitter can be configured to transmit a first acoustic wave in one or more directions. The base transducer system can include a processing means, a first base transducer having a first acoustic receiver, a second base transducer having a second acoustic receiver, and a third base transducer having a third acoustic receiver. Each acoustic receiver can be configured to receive said first acoustic wave from the remote transducer system.

### CROSS-REFERENCE TO RELATED APPLICATION

This patent application claims priority to U.S. Provisional 62/557,154 filed Sep. 12, 2017, and U.S. Provisional 62/557,156 filed Sep. 12, 2017 the disclosures of which are considered part of the disclosure of this application and is hereby incorporated by reference in its entirety.

### FIELD OF THE INVENTION

This invention relates generally to methods and systems for performing a subsea positioning and surveying using remote tracking and guidance of subsea probes and, more particularly positioning subsea probes to a desired location using acoustic transducers.

### BACKGROUND

A problem commonly encountered underwater is an inability to accurately determine absolute position. Because high frequency radio waves do not propagate through water, direct reception of GPS or other RF signals, which would otherwise provide good positional information, is not possible. Long baseline positioning systems use multiple transponders that are placed far apart on the seafloor. Their locations must be surveyed after deployment and they must eventually be retrieved, making their use cumbersome and costly.

Being able to track the exact position, including coordinates and depth, of an object under the water surface in real time is a challenge, which can be presently overcome if a surface vessel accompanies the subsea object in near vicinity (close geodesic coordinates). The surface vessel either needs to be connected to the under-water object through an umbilical, or it needs to be equipped with sophisticated communications equipment, which can receive and interpret detailed data from navigation sensors on board the under-water object. This mode of operation has two main disadvantages. First, the aforementioned navigation sensors on board the under-water objects (which includes precision gyros and inertial sensors) are both costly and comprise a significant drain on the power source of the under-water object (for example, the batteries in Autonomous Underwater Vehicles). Secondly, any surface vessel capable of operating offshore and analyzing navigation data from the under-water object is fairly large and expensive to operate. Current methods for delivering subsea probes, such as those embodied in U.S. Pat. Nos. 9,090,319 and 6,854,410, either require expensive autonomous systems that if lost will carry a substantial cost, or require to be tethered, which is operationally slower and therefore more expensive.

Further, in many commercial offshore scenarios, such as oil and gas exploration and production areas, many other vessels operate simultaneously, placing time constraints on the operational schedule of a vessel to avoid collisions with other vessels and therefore further increasing the costs.

There are many commercial offshore applications in which one surface vessel deploys and retrieves multiple subsea probes. Examples include ocean bottom seismic surveys, chemical surveys for environmental toxins or hydrocarbons (“sniffing”), or offshore electromagnetic methods (controlled-source electromagnetic or magneto-telluric surveys), such as those embodied in U.S. Pat. Nos. 9,013,953, 7,109,717 or 8,579,545

Many present subsea navigation methods rely on technology which is dual-use, i.e., which can be used for both military and commercial applications, and which therefore adds extra time and cost to sell equipment and services across international borders. A simple technology, which can track the position of an under-water object, which has no meaningful military applications, can be desirable, especially in the global nature of many subsea applications, such as oil and gas exploration and production.

In many applications, existing acoustic communications between an under-water object and a surface vessel use costly subsea modems, while the requirements are limited to navigation- or other low-bandwidth data. Further, many off-the-shelf modems do not meet the requirements for use in deep water, and specifically for use in ultra-deep-water oil and gas exploration and production applications. Therefore, a low-cost node which yields navigation data and which can be deployed in shallow and deep water alike will significantly lower the cost of operations.

There exists a need for an accurate method to determine the position of such under-water objects (seismic nodes, chemical nodes, electromagnetic loggers) without the surface vessel having to be in the near vicinity, while the under-water object reaches its destination, which would increase the productivity of these costly survey methods. Similarly, there exists a need for an effective method and system for delivering subsea probes to a desired and precisely predetermined location on the sea floor that can later be retrieved and reused, which is less costly than fully maneuverable autonomous underwater vehicles or submersibles.

### BRIEF SUMMARY OF THE INVENTION

In one aspect, this disclosure is related to a cost-effective system and method to track the exact position of an under-water object, which can fundamentally change the mode of operation of many commercial tasks in the offshore and subsea industries. One exemplary embodiment of the system of the present disclosure may be used for many quality control surveys for offshore construction applications, which can be changed from deploying tethered Remote Operating Vehicles (ROV's) to Autonomous Underwater Vehicle (AUV's). Another example embodiment of the present disclosure can include offshore data loggers, such as in ocean-bottom seismic surveys or EM-geophysics surveys (controlled-source electromagnetic or magneto-telluric) which can, instead of being drop-deployed by a surface vessel, move to their destined location partially self-propelled and with low-cost on-board navigation and propulsion.

In another aspect, this disclosure is related to a non-dual use technology solution, which relies on propagation time triangulation and waveform analysis of customized acoustic pulses to find object coordinates under the water surface, without requiring a large surface vessel, or sophisticated navigation sensors attached to the object, for subsea localization of an under-water object.

In another aspect, this disclosure is related to a group of acoustic transducers in a triangular configuration, which may be located at a depth shallow enough to allow for easy wireless or wired communication to surface vessels, and track a remote object by exchanging specific acoustic pulses, with another acoustic transducer placed on the under-water object to be tracked. Objects to be tracked can include, but are not limited to, subsea nodes, subsea probes, AUV's or any other object(s) to be tracked that may need to be tracked above or below water.

In another aspect, this disclosure is related to a system having at least one transducer that may be part of a fully autonomous transducer system, so that it does not need to be integrated into the power- and communications systems of the under-water object to be tracked. Furthermore, the system can transmit signals on at least one preset point in time, whereas in other embodiments, it may only transmit a second signal after receiving a first signal. Some embodiments disclosed may not require bidirectional communication, adding simplicity and keeping the costs low.

Certain embodiments can be deployed with a wide range of offshore equipment. An overview of the many applications follows which, however, is not exhaustive, and anybody skilled in the art shall recognize that the following readily applies to the widest possible variation of deployment modes.

In another aspect, this disclosure is related to geophysical survey methods in which individual non-tethered nodes are deployed, each node can be outfit with a transducer system. When the nodes are deployed from a surface vessel, the surface vessel will not have to stay close until the nodes reach the sea-bed, which can take a substantial amount of time, but can continue to the next deployment points and still track the location of previous nodes. In some embodiments, the nodes can be equipped with a navigation module, which can use a simple propulsion system with or without buoyancy control, which can move the nodes to a desired target location. The navigation module can include a remote acoustic transducer.

In yet another aspect, this disclosure is related to improving the navigation of massive equipment, which is towed with an umbilical by a surface vessel, for example the source dipole in controlled-source electromagnetics. This umbilical can be several miles long in deep water.

In another aspect, this disclosure is related to a transducer system that can be added to existing AUV's, simplifying their tracking over long distances of up to many miles. After enhancement, some tasks for which ROV's are used today, such as inspection of subsea infrastructure including offshore oil and gas production facilities, pipelines or subsea communication or power cables, can be conducted by AUV's, which can be cheaper to operate on account of not being tethered to a surface vessel.

In yet another aspect, this disclosure is related to a near-surface group of acoustic transducers that may be floating at shallow depths under the water surface, with only an RF communication antenna protruding above the surface. Thus, their operation is more feasible in busy offshore industrial sites, where vessel operation permits are challenging to schedule.

In another aspect, this disclosure is related to equipment designed to be rugged, simple, low-maintenance and self-contained, such that it does not require access to power infrastructure or computational bandwidth of the under-water equipment it is designed to track.

Certain embodiments of the present disclosure may be enabled via the presently disclosed underwater tracking technology for objects on or under the water surface. This technology may be typically based on three or more near-surface, or base-, acoustic transducer systems, which can be aligned in a non-linear arrangement, and which can exchange specially designed acoustic pulses with at least one remote transducer system, which can be located a distance of up to about tens of Nautical miles away, and at arbitrary water depths. It is understood that the term transducer system may cover a system with a transmitter and receiver, only a transmitter, or only a receiver, depending on the application.

In another aspect, this disclosure is related to a remote transducer system that can transmit a specially designed acoustic pulse, which may be received by the near-surface transducer systems, where the location of the remote transducer system may be determined through propagation time triangulation and waveform analysis, rendering any sophisticated navigation equipment at the location of the remote transducer system unnecessary.

The acoustic pulses can be encoded such as to prevent misidentification with other under-water equipment present, which also transmits acoustic pulses, and might contain a unique identifier in case multiple remote transducer systems are deployed. It might also be used to transmit low-bandwidth data, which might be sensor data from equipment the remote transducer system is attached to, or receive navigation commands from the base transducer systems, which can be used to steer equipment or objects, to which the remote transducer system is attached, in a direction.

In another aspect, the disclosure is related to a base transducer systems that can be located on or near the water surface, and can be in wired or wireless communication with a manned or unmanned surface craft, which receives the position data of at least one remote transducer system and makes higher-level decisions based on the location of the remote transducer systems. One of the base transducer systems, or a transducer system in a third location, can transmit signals to the remote transducer system in in one-way or two-way communication embodiments.

In another aspect, the disclosure is related to an underwater remote locator device for tracking and position an object. The system can include a remote transducer system, a base transducer system, and a navigation module. The remote transducer system can be coupled to an object desired to be tracked. The remote transducer system can include a power source, processing means, acoustic receiver, and an acoustic transmitter. The acoustic transmitter can be configured to transmit a first acoustic wave in one or more directions. The base transducer system can include a processing means, a a first base transducer having a first acoustic receiver, a second base transducer having a second acoustic receiver, and a third base transducer having a third acoustic receiver. Each acoustic receiver is configured to receive said first acoustic wave from the remote transducer system. In some exemplary embodiments, one or more of the base transducers can further include an acoustic transmitter that can be configured to transmit a second acoustic wave in the direction of said object. The navigation module coupled to the object or remote transducer system. The navigation module can include a propulsion system and a steering system. The navigation module can be communicatively coupled to said remote transducer system. The remote transducer system can be configured to receive the second acoustic wave. The second acoustic wave can contain a first data set. In some exemplary embodiments, the first data set can be encoded navigation commands to be executed by said processing means of the remote transducer system and initiate one or more actions by the propulsion system and steering system.

In another aspect, this disclosure is related to a method to place at least one object dropped from the water surface to a desired location at the water bottom. A first device, second device, third device, forth device, fifth device and at least one object to be tracked can be provided. The first device can include a first acoustic transmitter and a first acoustic receiver, wherein the first device can be coupled to said object. A propulsion system coupled directly to said object or to said first device can be provided. A first acoustic can be transmitted wave in one or more directions using said first acoustic transmitter. The first acoustic wave can be received by a second acoustic receiver on a second device, a third acoustic receiver on a third device, and a fourth acoustic receiver on a said fourth device. A second acoustic wave can be transmitted in the direction of said object by a second transmitter of the fifth device. The second acoustic wave can be received by the first receiver, wherein the second acoustic wave contains first data set. The first data set can include encoded navigation commands.

### BRIEF DESCRIPTION OF THE DRAWINGS

FIG. 1 is an illustration of a single remote transducer system communicating with a base transducer system.

FIG. 2 is an illustration of a multiple remote transducer systems communicating with the base transducer systems.

FIG. 3 is a graphical illustration of different types of pulses, which can be used to determine the position of remote transducers, and two examples for methods to encode digital information in transmitted acoustic signals (amplitude- and frequency modulation).

FIG. 4A is an illustration of communication between a base transducer systems and the at least one remote transducer system, wherein the remote transducer systems is located near the water bottom transmitting a pulse each in a direction towards the base transducer system located near the water surface.

FIG. 4B is an illustration of communication between a base transducer system and the at least one remote transducer system, wherein transmission of the signals from the remote transducer systems near the water bottom are triggered by a polling command sent out from another transmitter.

FIG. 5A is an illustration of a configuration of the deployment of a base transducer system in a towed array, wherein the base transducer system can be attached to surface buoys, which form part of an array towed by a surface vessel across the water surface.

FIG. 5B is an illustration of a configuration of the deployment of a base transducer system in a towed array, wherein the base transducer systems is towed in an array by a vessel on the water surface, but completely submerged.

FIG. 5C is an illustration of a configuration of the deployment of a base transducer system in a towed array, wherein the base transducer systems and buoys on or near the water surface can be held together by solid struts and towed by a vessel on the water surface through an umbilical line.

FIG. 5D is an illustration of a configuration of the deployment of a base transducer system in a towed array, wherein the vessel on the water surface can be connected to a pilot system through an umbilical line.

FIG. 6A is an illustration of an exemplary configuration of the deployment of the base transducer system having an autonomously operating array, wherein the array with the base transducer systems may not be attached in any way to the vessel, but can move independently as its own navigating vessel on, near or below the water surface with solid struts between the base transducer systems

FIG. 6B is an illustration of an exemplary configuration of the deployment of the base transducer system, wherein the base transducer systems can be mounted on self-propelled vehicles located on, near or below the water surface, propelled and steered by mobility systems.

FIG. 7A is an illustration of an exemplary deployment option of the remote transducer systems on at least one geophysical node which can be drop-deployed from a surface vessel and tracked as it descends.

FIG. 7B is an illustration of an exemplary deployment option of the remote transducer systems on at least one geophysical node which can be drop-deployed from a surface vessel and guided to a desired location through the knowledge of its position and a low-cost add-on propulsion system without buoyancy control.

FIG. 8 is an illustration of an exemplary deployment option of a remote transducer system on at least one autonomous underwater vehicle (AUV), which can be guided through a series of waypoints through the knowledge of its position by a surface vessel.

FIG. 9 is a flow chart of an exemplary exchange of encoded signals between the base transducer systems and the at least one remote transducer system, wherein from the triangulation of the arrival in the base transducer systems of specifically designed pulses transmitted by the remote transducer system, the position of the remote transducer system is determined.

FIG. 10 is a flow chart of an exemplary sequence of communication events in an exemplary embodiment of the present disclosure, which can determine the position of a subsea object upon the remote transducer system being polled by the base transducer system, and the subsequent transmission of encoded commands from the base transducer system through the remote transducer system to the piece of under-water equipment the remote transducer system is attached to.

FIG. 11 is an illustration of an exemplary communication system of the present disclosure.

FIG. 12 is an illustration of an exemplary communication system of the present disclosure.

FIG. 13 is an illustration of an exemplary communication system of the present disclosure.

FIG. 14 is an illustration of an exemplary communication system of the present disclosure.

FIG. 15 illustrates a block diagram of an exemplary remote transducer system of the present disclosure.

FIG. 16 illustrates a block diagram of an exemplary base transducer system of the present disclosure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Embodiments of the present disclosure provide a system and a method for a remote locator device for use in, on, or under water applications, shallow water, deep water, and other fluid pool applications. In order to locate a remote under-water object, the invention does not require any navigation sensors on the remote object itself, but relies solely on a combination of the propagation timing delay and the phase delay in the detection of specially designed acoustic pulses transmitted from the remote under-water object between one or more acoustic receivers. In some exemplary embodiments the acoustic receivers can include three spatially separated and not linearly aligned base acoustic receiver.

A simple system in accordance with the present disclosure can include base transducer systems and may be located on or near the water surface of a water body, with a remote transducer system typically located at a water depth much greater than the base transducer systems. The system can include a plurality of remote transducer systems, which can be deployed in a targeted or random means. The remote transducer(s) can be customized to shallow- and deep-water applications in any body of water. The remote transducer system can be attached to any object to be tracked on or under the water surface. In some exemplary embodiments, an object can include a tethering means, wherein the object acts as a weight to carry the remote transducer system to the bottom surface of the body of water. Other exemplary embodiments can be used without a tethering means. Similarly, the object can be configured to carry the remote transducer system to a targeted depth.

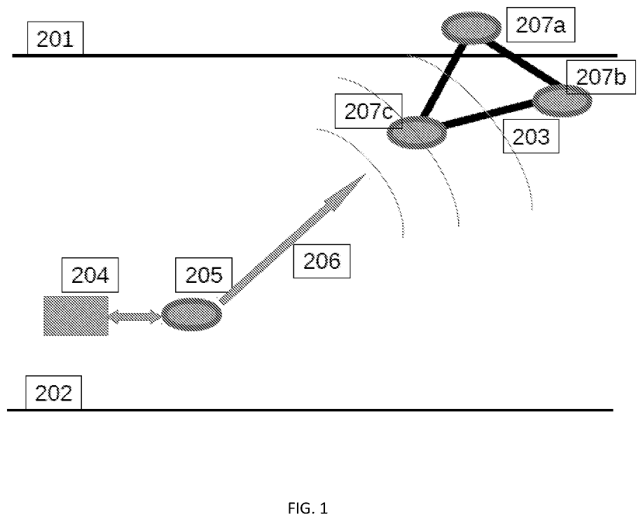

Referring to FIG. 1, at least one transmitter 205 of the remote transducer system of the present disclosure can be attached to an object, such as a geophysical node, autonomous underwater vehicle (AUV), environmental or chemical sampling node, or any other sensor system or object to be tracked 204, generates an isotropic or directional acoustic pulse 206 through a means of converting an arbitrary waveform into acoustic energy propagating through water. In some embodiments, this can be accomplished by commercial underwater transducers, or generally any piezoelectric method. In other embodiments, it can be a means to convert chemical energy into vibrations, such as generating short, controlled series of chemical combustions. In yet other embodiments, it can be accomplished through a pressured gas, which is released through a mechanical transducer in a controlled way, thus generating sound waves. It is understood that the remote transducer system can contain both an acoustic transmitter and receiver in some embodiments, while it can contain only a transmitter in other embodiments.

Again referring to FIG. 1, one exemplary embodiment of the base receiver system 203 can include at least three base receivers 207a, 207b, 207c, which can be used to determine the position of a remote transmitter 205 either through the measurement of the time-of-flight difference of a wave packet, or through phase information from at least one frequency of propagating waves 206 in the water, or a combination of both. It is understood that the base transducer systems 203 can contain both an acoustic transmitter and receiver in some embodiments, while it may only contain a receiver in other embodiments.

The acoustic pulses in the, typically three or more, base receivers 207a-c can get measured through any means, which converts acoustic waves into a digital representation of the amplitude of the acoustic wave versus time. In some embodiments, this might include a hydrophone, which is based on the piezoelectric conversion of sound into electrical signals. The generated electrical signals can then be converted to digital information through an analog-to-digital converter. Subsequently, the digital information may be preprocessed on each of the base receivers, and then transmitted to a processing unit, followed by an analysis unit—the processing—and analysis units may be wired or wireless communication with the at least three base receiver system 203. In other embodiments, the entire processing might occur on one or more of the base receivers 207a-c, in which case at least one of the base receivers 207 carries at least the processing unit, possibly also the analysis unit. Again, it is understood that the base transducer systems 203 can contain both an acoustic transmitter and receiver in some embodiments, while it can contain only a receiver in other embodiments.

The acoustic pulses in the at least three receivers can also get measured through any means which converts acoustic waves into a different waveform which may get recorded on an analog recording system. In one specific embodiment, the different waveform can be comprised by a time-dependent electric signal, which can get passed through an amplifier stage and then stored on a magnetic tape. In another embodiment, the different waveform may get transmitted through an analog channel to a processing- and analysis units. The channel may be wired or wireless, for example analog radio signals. The base transducer systems can contain both an acoustic transmitter and receiver in some embodiments, while it can contain only a receiver in other embodiments.

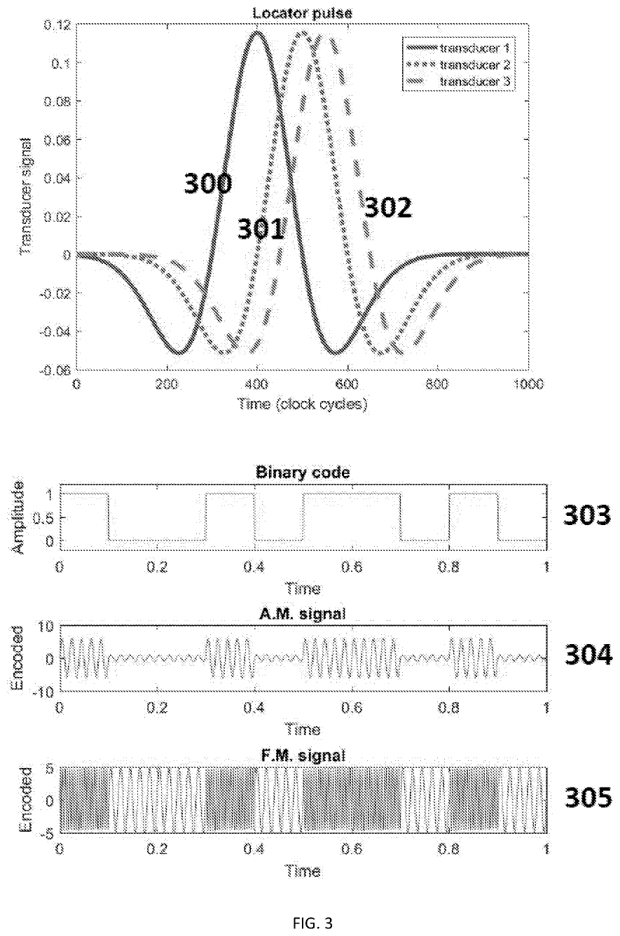

In some exemplary embodiments, processing of the signals from the transducers can occur using an approach which is a combination of analog and digital technology. Referring to FIG. 3, one example embodiment is the analog measurement and processing of such acoustic pulses, which are designed to determine the position of the remote transducer unit, which are received by typically three base transducer systems, and are illustrated as 300, 301 and 302 in FIG. 3. In contrast, binary decoding and digital processing is applied to decode such acoustic pulses which are encoded to carry information exemplified by 303, for example as an amplitude-modulated pulse 304, or a frequency-modulated pulse 305.

The processing unit can perform signal processing. The analysis unit can perform an interpretation or analysis of specially designed wave packets from the base receivers to determine the position of the remote transducer system. The processing and analysis units may center on a CPU (central processing unit), which can be a microcontroller, DSP, GPU, FPGA, or a general-purpose CPU or collection of parallel general-purpose CPU's, such as used in personal computers.

The analysis unit draws conclusions from the position determined of the at least one remote transducer system, and takes higher-level decisions. It can be comprised by a graphical or other output of the data, upon which human beings take the higher-level decisions, or the higher-level decisions can be conducted by a simulated artificial intelligence or other higher-level algorithm. Part of the decision, in either scenario, is to store the location data in non-volatile memory.

It is understood that sound waves are subject to diffraction, associated with a change of direction, when encountering discontinuities. In the ocean, these discontinuities may be due to ocean currents or ocean layers of varying temperature, salinity and pollutants. Further, reflections of the water bottom and water surface will result in multiple signatures of the same pulse at different times, which is complicated by variations in bathymetry. In some embodiments, particularly in offshore industrial sites with a high level of activity, these effects are taken into account by using known ocean conditions and a known background model to conduct a proper data inversion of the received waveforms to determine the true position of the remote transducer system. In other embodiments, the remote transducer system is tracked from relatively close proximity to the base receivers, until it reaches its destination. Thus, by tracking the gradual evolution of the signal pattern, an inversion can be conducted to determine both the position of the remote transducer system versus time, and also a distribution of the ocean water conditions—including salinity and temperature—along the travel path. The latter situation will be more typical for scenarios in less surveyed areas, such as frontier oil and gas exploration.

It is understood that higher frequencies are more attenuated than lower frequencies, and that wave packets centered on a certain point in time with a narrow width Δt₀ at their point of origin experience dispersion after traversing some distance, resulting in an increase in their time window Δt₁>Δt₀. The better localized in time a wave-packet is at its source, the more frequencies it consists of, and the more it will experience dispersion. Hence, the frequency and transmitted waveform is adapted to the application, mainly the required travel time. For longer distances, lower frequencies are required, as well as longer wave-packets in time. Therefore, resolution and bandwidth are sacrificed for longer distances between source transmitter and base receivers.

In some simpler embodiments of the invention, waveforms consisting of a superposition of frequencies will be transmitted by the remote transducer without encoding any additional information. In that case, the position of the remote transmitter will be determined through the relative signal phase and signal amplitude information received in the base transducer systems, which will, in this most simple implementation, only consist of one receiver in each base transducer system. With reference to FIG. 1, the base transducer systems 203 are therefore only comprised of receivers. Since no information on the identity of the remote transmitter is encoded in that case, this scenario is, in practice, limited to frontier cases with few to no other acoustic signal transmissions using the same frequency ranges.

Again referring to FIG. 1, in an embodiment, which is further simplified, no transmission of information to the remote transducer system is required, and the remote transducer system 205, which is attached to the object 204, might only contain a transmitter and no receiver to save cost.

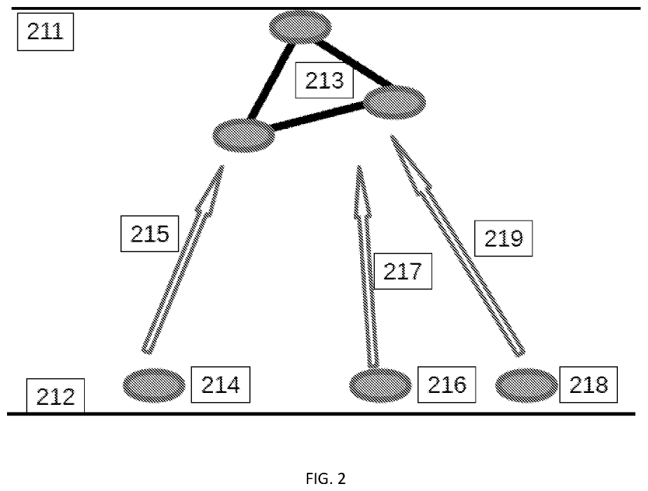

In other embodiments, illustrated in FIG. 2, multiple remote transducer systems 214, 216, 218 can send pulses 215, 217, 219 to a base transducer system 213. The pulses can encode a unique identifying marker of each transducer system. The unique identifier can be any information which can be encoded in a binary sequence, such as a device number or a serial number. Beyond a unique identifier, other useful information can be transmitted, which can include instrument status data such as battery status, or sensor data from any pieces of under-water equipment the remote transducer system is attached to, or data from auxiliary sensors the remote transducer is equipped with itself, such as pressure-, temperature-, or turbidity sensors.

Referring to FIG. 3, complex information 303 beyond a localization pulse (300, 301 or 302) can be encoded in either amplitude-(304) or frequency-modulated (305) binary sequences. The amplitude modulation can be comprised by variations of the amplitude between a greater and a smaller amplitude in a carrier wave. The smaller amplitude can also be zero. The greater and smaller amplitudes over predefined durations refer to, respectively, logical zeros and ones. The frequency modulation can be comprised by different frequencies over predefined time periods, where one type of frequency modulations represents logical zero, and another type of frequency modulation represents logical one.

In one example embodiment of the invention, the signal can be scanned and read by the one or more processing units attached to or in communication with the base transducer systems through an appropriate series of filters consisting of at least one digital filter. The at least one digital filter can include a low-pass filter or a down-sampling filter for data reduction, an anti-aliasing filter, as well as at least one filter for frame synchronization. The filter for frame synchronization can include a matched filter appropriate to an instruction set, and a maximum detector to optimize the gain in the analog front. Specific sequences known in the art to be of minimum auto-correlation, such as Barker sequences, can be used to set the time reference for the signal transmission.

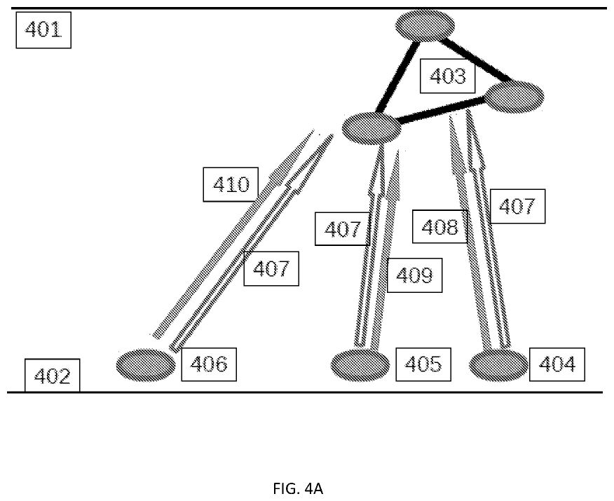

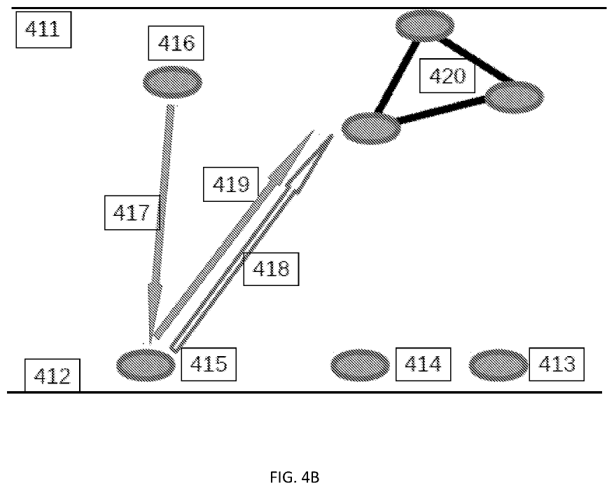

In some embodiments, the transmission of signals from the remote transducer system to the base transducer systems can be unidirectional, and is either continuous, or automatically triggered in a predetermined timing pattern. Referring to FIG. 4A, an example embodiment shows the remote transducer systems 404, 405 and 406 near the water bottom 402 in the example embodiment shown, transmitting, not simultaneously, a pulse 407 each in a direction towards the base transducer system 403, located near the water surface 401. Subsequent to the pulse 407, which is used to determine the position of the remote transducer systems, the remote transducer systems might also transmit other pulses 408, 409 and 410, encoding information specific to each system, including, but not limited to a unique identifier.

In another example embodiment different from the latter, illustrated in FIG. 4B, the transmission of the signals from the remote transducer systems 413, 414, 415 near the water bottom 412 are triggered by a polling command 417 sent out from another transmitter 416. The another transmitter 416 can be co-located with the base transducer system 420, can be identical to a transmitter component as being part of one of the base transducer systems in 420, or it can be located in any location in range of the remote transducer system, as long as the transmitter 416 is in wired or wireless communication with the same analysis unit the base transducer system 420 is connected to. The polling command 417 can be received by multiple remote transducer systems 413, 414, or 415, but it encodes a unique identifier corresponding to a specific remote transducer system, depicted as 415 in FIG. 4B. It is understood that this embodiment requires that the remote transducer systems which shall receive the command 417 shall contain both a receiver and a transmitter. Once the command 417 is decoded, the remote transducer system 415 transmits a pulse 418 in a direction towards the base transducer systems 420. The pulse 418 is used to determine the position of the remote transducer systems 415. The remote transducer system 415 might also transmit another pulse 419, encoding information specific to the remote transducer system 415.

It is understood that the remote transducer system will always contain at least one acoustic transmitter, and, in some embodiments, also at least one acoustic receiver. These can be the same device, or separate devices, and can be controlled by a common processing unit, which can be a microcontroller, DSP, GPU, FPGA, or any CPU. The decoding in the remote receiver can be conducted in a similar way as the decoding in the base transducer systems, or in a different way.

As shown in FIG. 4B, the transmitter 416 and the base transducer systems 420 can be different physical devices, and do not need to be co-located. In all embodiments, every one of the base transducer systems 420 will contain at least one acoustic receiver, whereas in some embodiments, one or more of the base transducer systems will also contain at least one acoustic transmitter, which can be functionally identical to the transmitter 416.

In some embodiments, the at least one frequency for communication and localization is fixed and selected according to the desired range and resolution, whereas in other embodiments, the at least one frequency is modified according to the position of the at least one remote transducer system. In some exemplary embodiments, the at least one frequency might be selected according to a known water depth profile in a location, or the water depth measured through an appropriate sensor built into or connected to the remote transducer system, whereas in others of the latter embodiments, the at least one frequency is modified in response to commands transmitted from a transmitter near the surface (such as 416 in FIG. 4B) to the at least one remote transducer system.

In some exemplary embodiments, the frequency of the acoustic carrier wave can be in the range from about 10 Hz to about 10 kHz. In other embodiments, the frequency range will be lower, and can be as low as about 1 Hz, or higher, extending into the about 200 kHz range. In yet other embodiments, any other frequency range might be chosen.

The components of the remote transducer system which do not need to be exposed to the water to ensure their proper functioning may be placed in a separate enclosure, or it may be placed into the enclosure of another piece of under-water equipment, which may be tracked. The enclosure can be designed to sustain sufficiently high pressures to operate in any commercially relevant water depth. In one specific embodiment, the enclosure is designed to a crush depth of up to about 4000 m for ultra-deep water applications, whereas in other embodiments, a lower-cost enclosure is used which is rated to less than about 100 m, or the enclosure might be rated to any other water depth. The transducer system can be designed in a modular fashion so that it can be placed into a different enclosure customized for different water depths and environments.

The remote transducer system can be powered by its own power source located in its own enclosure, or it can be powered by an external power source located on a separate piece of under-water equipment, which the remote transducer system might be tasked to track. Typically, the power source will be a chemical battery, but it can be any suitable power source, which can generate electricity, including a fuel cell, solar cell, or a water turbine or any other power harvesting method. In some embodiments, the remote transducer system may be in wired or close-range wireless communication with a piece of under-water equipment, which it exchanges information with. This information exchanged can include sensor data or operational status information. In other embodiments, it might be only mechanically connected to a piece of under-water equipment or object, which it might be tasked to track, in order to save cost and simplify deployment.

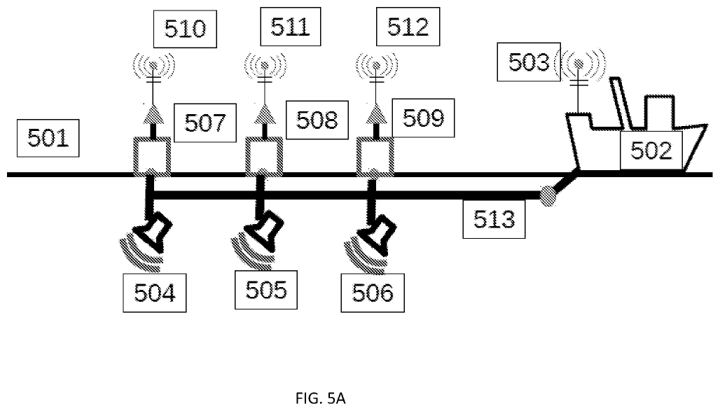

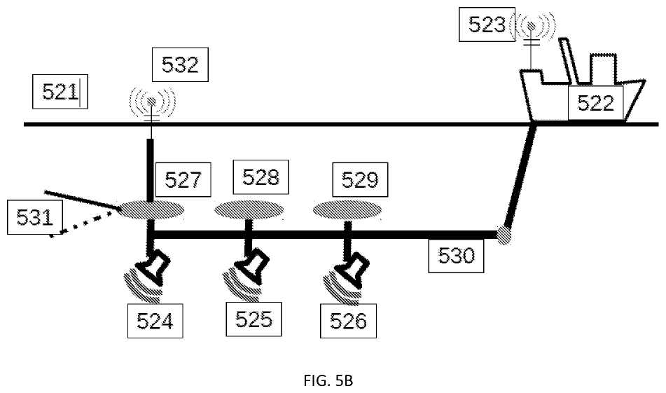

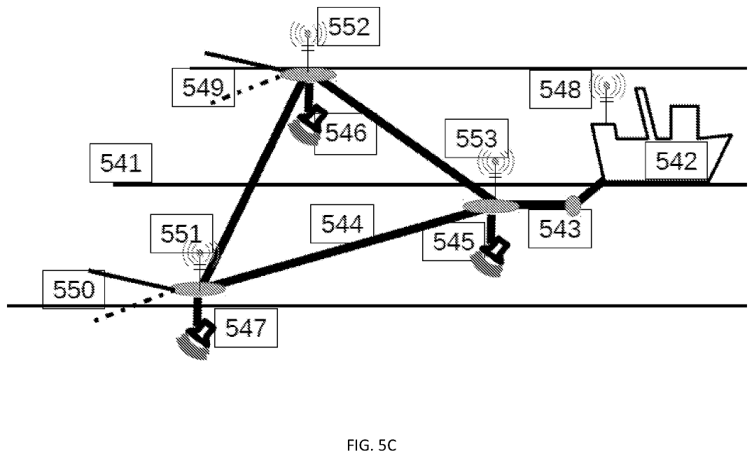

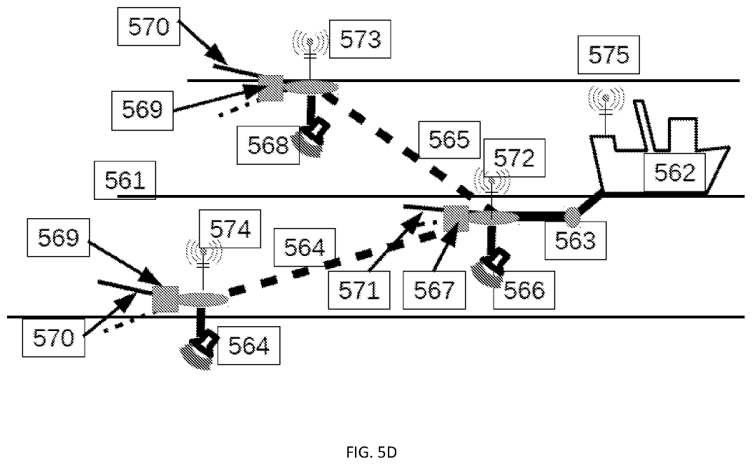

Referring to FIG. 5A the base transducer systems 504, 505, 506 can be attached to surface buoys 507, 508, 509, which form part of an array 513 towed by a surface vessel 502 across the water surface 501. The base transducer systems 504, 505, 506 in the towed array 513 can be held together by one or more cables attached to one or more booms of the towing vessel 502. The base transducer systems can be on or near the surface, attached to the surface buoys 507, 508, 509, or suspended from the surface buoys and hanging into the water. Communication between the vessel and the base transducer systems can either be wired, or wireless, for example as illustrated in FIG. 5A, between wireless nodes 510, 511, 512 attached to the buoys 507, 508, 509 and a wireless node 503 attached to the surface vessel 502.

Referring to FIG. 5B, another embodiment shows the base transducer systems 524, 525, 526 being also towed in an array 530 by a vessel 522 on the water surface 521, but completely submerged. Again, the array 530 in the example embodiment shown is held together by one or more cables attached to one or more booms of the towing vessel 522. The array is held at a desired depth by either using one or more buoyancy control devices 527, 528, 529, or an active horizontal rudder 531 attached to at least one among the base transducer systems 524, 525, 526, or a combination of both. The vessel and the base transducer systems can be communicatively coupled using any suitable means, including a wired or wireless connection, the latter between a wireless node 523 on the vessel and at least one wireless node with an antenna 532 protruding above the water surface.

Referring to FIG. 5C, in another embodiment, systems 545, 546, 547, comprised by the base transducer systems and buoys on or near the water surface, might form part of an array which is held together by solid struts such as 544, and which is collectively towed by a vessel 542 on the water surface 541 through an umbilical 543. Said systems 545, 546, 547 may each be comprised by a buoy on the water surface, each with an attached submerged base transducer system, or may each be comprised by a buoyancy control system, each with an attached base transducer system. Lateral movement can be accomplished by rudders 549, 550 attached to at least one system 545, 546, 547. The rudders represented by 549, 550 may also represent horizontal rudders, which may control the depth of the collective array comprised by systems 545, 546, 547, which may have a small or zero net buoyancy. Communication between the vessel and the base transducer systems can either be wired, or wireless, for example as illustrated in FIG. 5C, between wireless nodes 551, 552, 553 attached to the systems 545, 546, 547 and a wireless node 548 attached to the surface vessel.

Referring to FIG. 5D, in a further example embodiment, the vessel 562 on the water surface 561 can be connected to a pilot system 566 through an umbilical 563. The pilot system can contain a base transducer system with buoyancy control 567, as well as a rudder system 571 for directional control. The pilot system further tows one or multiple systems 564 and 568, which are connected via umbilicals 564, 565 to the pilot system. Each secondary system may consist of a base transducer system with buoyancy control 569 and a rudder system 570 for directional control. In some embodiments, the length of each umbilical 564, 565 can be adjustable, whereas their lengths are fixed in other embodiments. Communication between the vessel and the base transducer systems can either be wired, or wireless, for example as illustrated in FIG. 5D, between a wireless node 575 on the vessel and at least one wireless node with an antenna 572, 573, 574 protruding above the water surface.

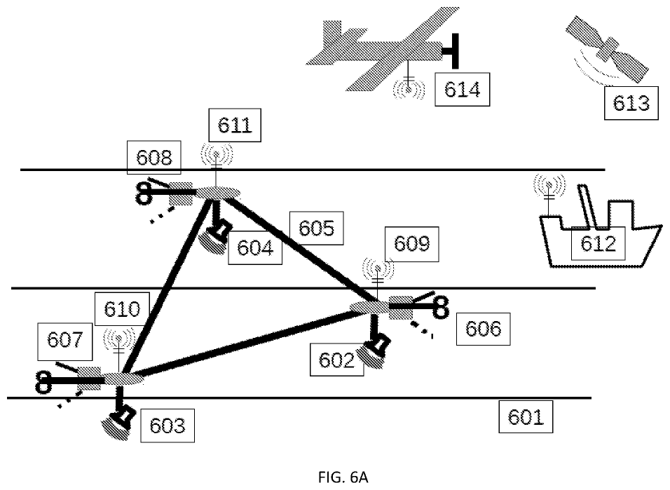

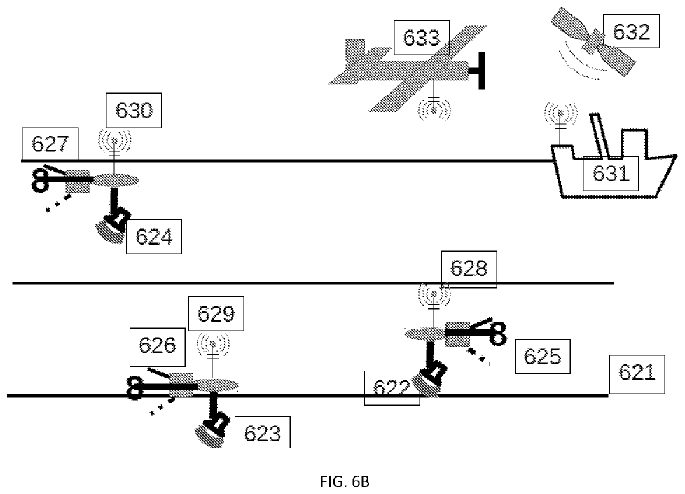

Referring to FIG. 6A, in a further embodiment, the array with the base transducer systems 602, 603, 604 might not be attached in any way to any vessel, but can move independently as its own navigating vessel on, near or below the water surface 601 with solid struts 605 between the base transducer systems. If the array is submerged, it is held at a desired depth by either using one or more buoyancy control devices, or an active horizontal rudder, or a combination of both. The rudder is part of a mobility system 606, 607, 608 on one or more of the base transponders, which can also consist of a thruster, such as a propeller, as illustrated in FIG. 6A. Communication between the vessel and the base transponders will be wireless, between wireless nodes on at least one base transducer system 609, 610, 611 and the vessel. In this case, the term “vessel” is to be understood in the most general sense, and can mean any remote station which is in wireless communication with the base transponders, and which makes higher-level decisions based on the navigation data obtained. This includes actual surface vessels 612, land-based stations in case of offshore locations close to a coast, airplanes or unmanned drones 614, or satellites 613. Airborne, seaborne or land-based stations in direct communication with the array can merely function as relay systems to facilitate communication with another vessel—again in the most general sense—at a different location.

Referring to FIG. 6B, in yet another embodiment, the base transducer systems 622, 623, 624 can be mounted on self-propelled vehicles located on, near or below the water surface 621, propelled and steered by mobility systems 625, 626, 627. The base transducer systems move autonomously as a swarm, adjusting their relative position so as to optimize the determination of the position of one or more remote transducer systems. Communication between the vessel and the base transducer systems will be wireless, between wireless nodes on at least one base transducer system 628, 629, 630 and the vessel. In this case, the term “vessel” is again to be understood in the most general sense, and can mean any remote station which is in wireless communication with the base transducer systems, and which makes higher-level decisions based on the navigation data obtained. This includes actual surface vessels 631, land-based stations in case of offshore locations close to a coast, airplanes or unmanned drones 633, or satellites 632. Airborne, seaborne or land-based stations in direct communication with the array might merely function as relay systems to facilitate communication with another vessel—again in the most general sense—at a different location.

The system of the present disclosure can provide a low-cost, low-power, and low-bandwidth, real-time navigation solution for subsea objects. The solution is designed to be able to temporarily or permanently retrofit any existing subsea objects. One set of base transducer systems shall be able to communicate with one or more remote transducer systems simultaneously, so that the positions of an entire fleet of subsea objects, such as a number of geophysical nodes, can be determined simultaneously.

To achieve the retrofit capability, the remote transducer system is designed to attach to any subsea objects through the use of a mechanical mounting bracket, mating mechanical connectors, magnetic mounting, or a combination of mechanical and magnetic methods. In other embodiments, a mechanical fixture may be installed to facilitate the application of disposable mounting solutions, such as plastic cable ties. The subsea objects can include geophysical nodes, such as ocean bottom seismic nodes, electromagnetic loggers for controlled-source electromagnetic or magneto-telluric surveys; geochemical nodes for environmental surveys or chemical trace detection of hydrocarbon or other mineral deposits; autonomous underwater vehicles; any other piece of offshore equipment which presently operates without a live bidirectional communication link, and which would benefit from transmitting its position to a central location.

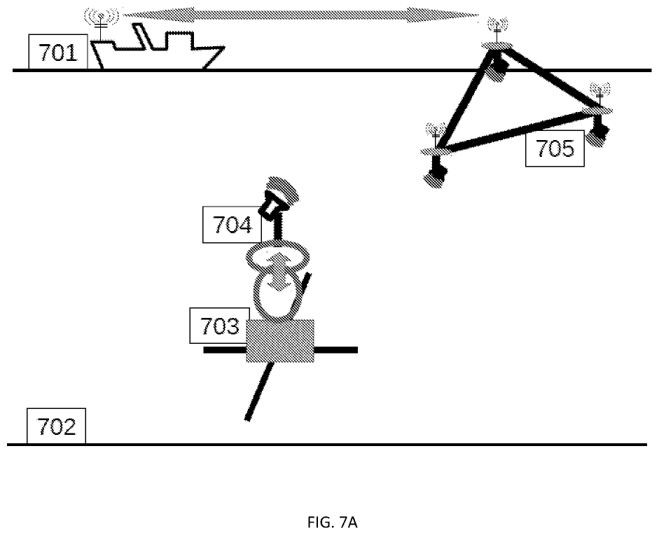

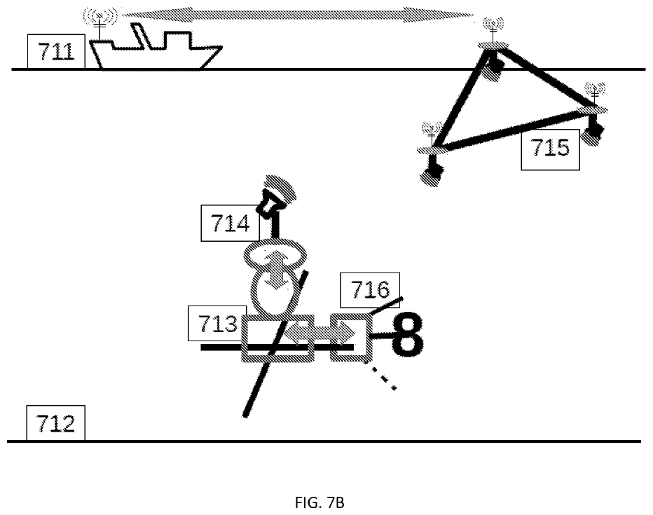

FIG. 7A illustrates the deployment of such pieces of offshore equipment 703 which, at the present state of the art, would be dropped or winched to the water bottom. This may include particularly geophysical nodes, which can be retrofit with the remote transducer systems 704 to provide position information relative to an array of base transducer systems 705. The base transducer systems could be either attached to a surface vessel 701, or in wireless communication with the vessel. In some embodiments, the vessel 701 is the same vessel, which deploys the objects to be tracked 703. The attached transducer system 704 enables the vessel to track the position of the object(s) 703 without remaining in near proximity of a drop location, and without requiring built-in positioning sensors with the object. This can significantly lower the cost of deploying multiple objects 703 to be tracked, and can increase the efficiency of deployment, as the deploying vessel no longer needs to remain near the deployed object(s) to be tracked 703 to determine their position during descent, which can take a considerable amount of time.

Referring to FIG. 7B, the deployed object(s) 713 can be retrofit with the remote transducer systems 714, as well as low-cost under-water propulsion systems with rudders 716 to render the deployed object(s) to be tracked maneuverable as they descend. The remote transducer systems 714 can be integrated with the low-cost under-water propulsion systems with rudders 716 in one common system or enclosure, or they can be comprised of two modular systems, at least one of which can be attached to the deployed object(s) to be tracked without the other. By tracking the position of the object(s) 713 relative to an array of base transducer systems 715, which is in communication with a surface vessel 711, object(s) can be steered to a desired location by transmitting navigation commands from the array of base transducers or another transmitter to the remote transducer systems 714. The benefits of the described retrofit include a more accurate landing of the object(s) to be tracked in a desired location, as well as a reduction of the distance traveled by the deploying vessel enabled by a degree of maneuverability of the deployed object(s) to be tracked, which lowers cost and saves time. In a fully navigable offshore vehicle, the most expensive and maintenance-intensive component is the buoyancy control. The system of the present disclosure can provide an add-on propulsion system without buoyancy control that will only add moderate cost to the system comprising at least the object(s) to be tracked 713. Examples for the propulsion in the propulsion system with rudders 716 are an electrically driven propeller or a reservoir of a pressured gas. Removal of buoyancy control drastically reduces the cost associated with adding propulsion capability, but the apparatus of the present disclosure can be coupled to the object(s) to be tracked 713 to provide simple directional propulsion to guide the objects to a desired location, while the objects are descending.

In one exemplary embodiment, a navigation module can be used to guide the object to be tracked into position. The navigation module can include a propulsion system and can be generally buoyant or coupled to a buoyant object. The propulsion system can then be coupled to an object to be tracked, or to the navigation module, which can in turn be coupled to an object to be tracked. The propulsion system can include a weighted apparatus to overcome the combined buoyancy of the object, propulsion system and transducer system and allow it to descend into the water. The weighted apparatus can be any suitable means, including a concrete weight configured to dissolve over a period of time. The weighted system can be releasably coupled in a manner where a simple disconnect to release the object(s) to be tracked from the weight can be triggered by an acoustic pulse sent to the remote transducer system, which is in communication with the releasable coupling. This weighted system can be a separate modular system, or it can be incorporated into the propulsion system. In some embodiments, the propulsion system and remote transducer system can remain coupled to, and be retrieved concurrently with, the object(s) to be tracked, and in other embodiments, the propulsion system and remote transducer system can be retrieved separately from the object(s) to be tracked.

In all of the objects to be tracked mentioned, the at least one remote transducer system mentioned exchanges specially designed pulses with the base transducer array, from which the location (geographic coordinates and water depth), as well as potentially other information encoded in the same or other pulses, can be interpreted.

In some embodiments, the base transducer array can be in wired or wireless communication with a manned or unmanned craft, which can be an offshore vessel from which operational decisions are made by a human crew or an artificial intelligence, or a predetermined computer algorithm. In other embodiments, communication with a control center can be conducted through one or a series of relay communication stations, which can include seaborne, airborne, satellite-based or land-based systems. From the control center, operational decisions based on position tracking of at least one remote transducer system may be made by a human crew or an artificial intelligence, or a predetermined computer algorithm.

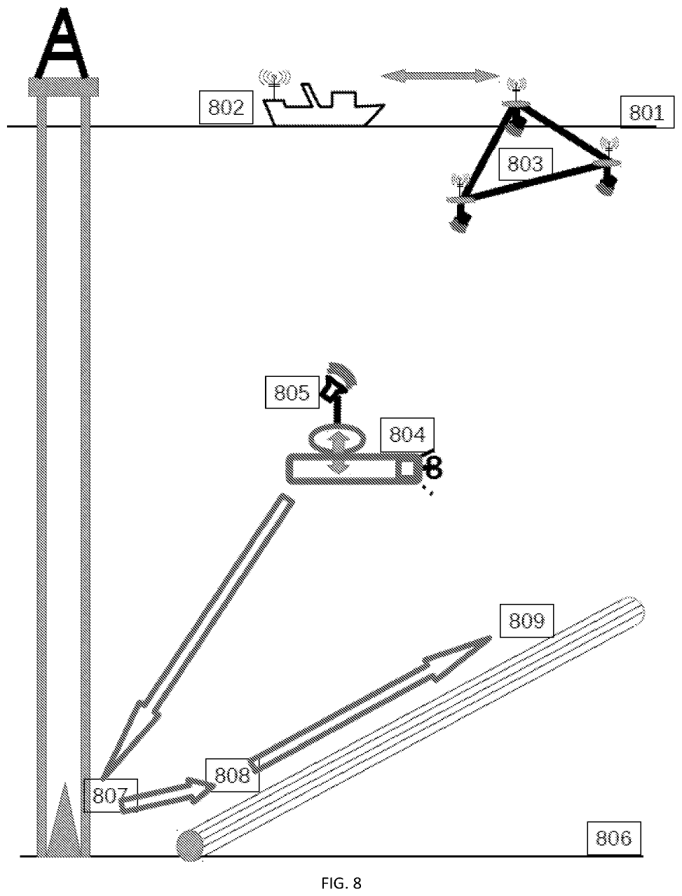

Referring to FIG. 8, an embodiment of the invention is in a deployment of at least one remote transducer system 805 on AUV's 804, wherein the position of the remote transducer system 805 is tracked relative to an array of base transducer systems 803, which is located on or near the water surface 801, and which is attached to, or in wired or wireless communication with a surface vessel 802. By receiving updates on the position of the at least one remote transducer system 805, the vessel 802 can initiate the transmission of navigation commands from the array of base transducers 803 or another transmitter in a different location to the at least one remote transducer system 805. Thus, the AUV can be guided through a series of waypoints to perform different tasks through the knowledge of its position. Examples for these waypoints include, but are not limited to, subsea oil and gas production infrastructure such as subsea trees 807 or locations 808, 809 along pipelines, some of which may include sensor systems relevant to the long-term and safe operation of the pipeline, such as sensors relating to cathodic protection systems or pressure gauges. Readings from the sensor systems along pipelines can either be stored in memory, or be transmitted to the base transducer systems while the AUV is operating, or a combination of both.

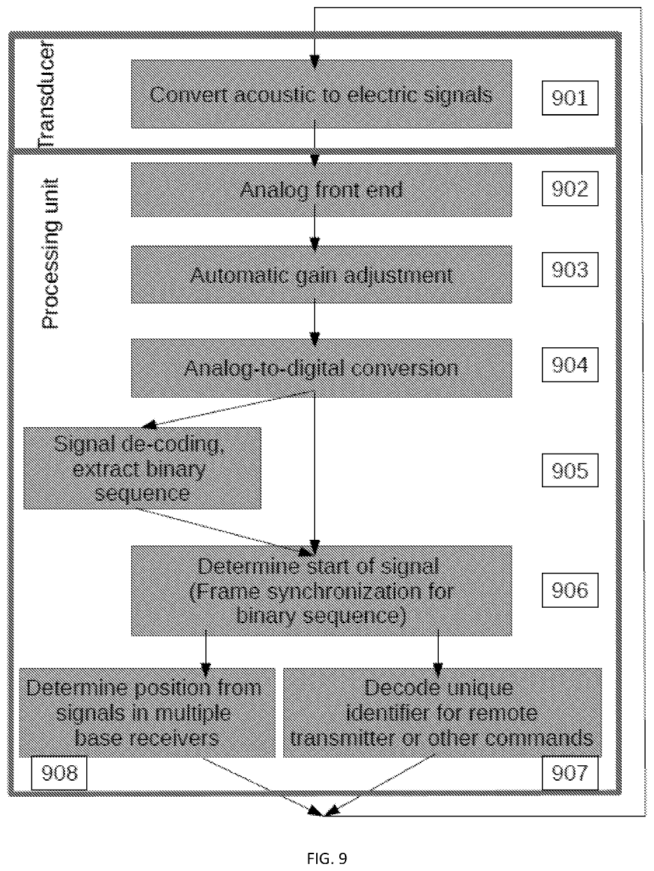

FIG. 9 shows a block diagram summarizing the sequence of steps of decoding and processing of signals in a receiver in one embodiment of the invention, for both the sequence of a locator pulse, as well as a digital pulse sequence. In an example embodiment, the transducer is a receiver on a base transducer system. The acoustic signals received by any of the base transducers are converted into electric signals in 901. Subsequently, an analog front end 902 may contain a band-pass filter for anti-aliasing and low-frequency offset removal. An automatic gain adjustment 903 may set the gain of an analog amplifier stage to optimize the dynamic range of the amplified signal for the analog-to-digital converter 904. For digitally encoded signals, signal de-coding (frequency- or amplitude-modulated) 905 results in a binary sequence, followed by digital frame synchronization 906. For locator pulses, the start of the signal 906 is determined through other means, such as physics-based time-domain pulse inversion. Following the frame synchronization step, either the binary commands—such as a unique identifier of the remote transducer system—are decoded in 907, or the position of the remote transducer system is determined from the locator pulses of the typically three base transducer systems in 908. It is understood that the embodiment demonstrated through FIG. 9 only requires unidirectional signal transmission from a remote transmitter and a set of base receivers.

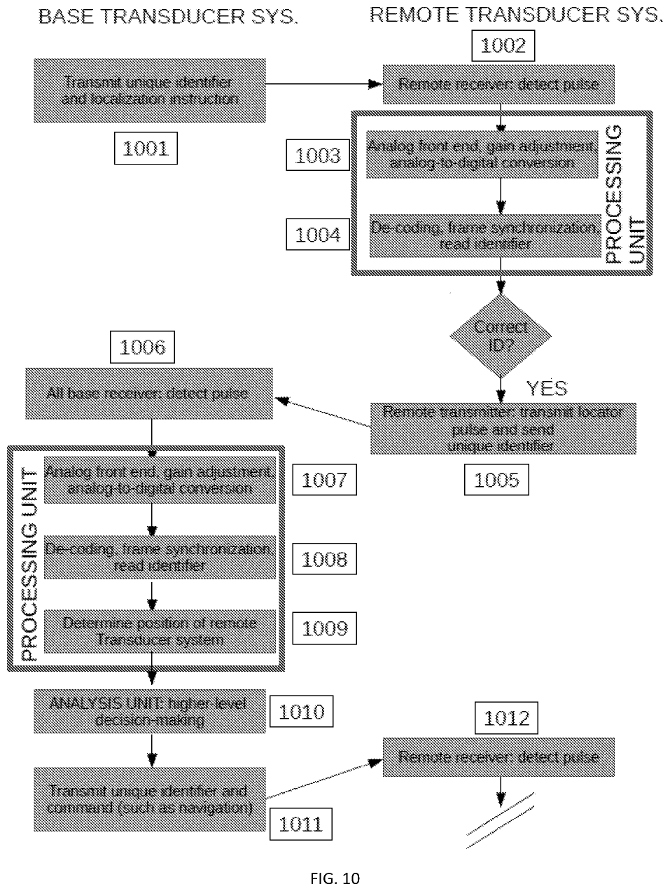

An embodiment employing two-way communication is shown in FIG. 10, a block diagram outlining a sequence of events included in the determination of the position of a subsea object upon the remote transducer system being polled by the base transducer system, and ultimately the transmission of encoded commands from the base transmitter to the remote transducer system, which can in some embodiments be attached to an object desired to be tracked. In some exemplary embodiments, the object being tracked can be communicatively coupled to the remote transducer system. Referring to FIG. 10, in 1001, the base transducer system transmits a command to a remote transducer system identified by a unique code in the command, with instructions for the remote transducer system to transmit a locator pulse. The remote receiver detects the pulse in 1002, whereupon a processing unit which is a part of, or attached to, the remote transducer system follows a sequence of processing steps substantially similar to the processing steps for digital signals described in FIG. 9: analog front end, gain adjustment and analog-to-digital conversion (1003), followed by de-coding, frame synchronization and reading the command (1004). If the unique identifier decoded in step 1004 matches the identifier of the specific remote transducer system, the latter transmits a locator pulse as well as a digitally encoded unique identifier, and possibly other information, in 1005. Detection of the locator pulse by the base transducer systems is followed by processing sequences 1007, 1008, 1009 substantially similar to the steps outlined in FIG. 9, first for the locator pulse, and then for the digitally encoded unique identifier of the remote transducer system. After the position of the remote transducer system is determined form the timing and phase information of the locator pulses received in the base transducer systems in 1009, an analysis unit 1010 in communication with the base transducer systems performs higher-level analysis of the position of at least one remote transducer system and formulates a response, which can, in some embodiments, take the form of the transmission of a navigation command in 1011, which is detected, decoded and acted upon in a useful way by the specifically addressed remote transducer system in 1012.

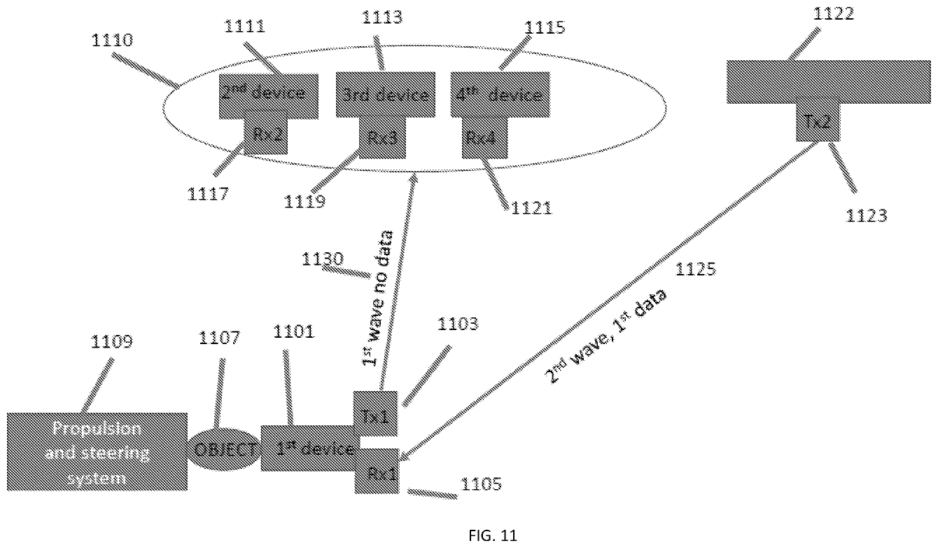

FIG. 11 shows an embodiment of the present disclosure. A first device 1101, such as a remote transducer system which can include an acoustic transmitter 1103 and receiver 1105, is attached to an under-water object 1107 to which is also attached a propulsion and steering system 1109. The propulsion and steering system may also be attached to the first device 1101, without being attached directly to the under-water object 1107. The first device 1101 can transmit a first acoustic wave in a direction towards a number of base transducer systems 1111, 1113, 1115, wherein each base transducer system can further include a corresponding receiver 1117, 1119, 1121. In one embodiment, the first wave 1130 does not contain any encoded digital data, but can merely serve for the base transducer systems to determine the position of the first device. Once the position has been determined, another transmitter 1123 can transmit a second wave with encoded first data 1125 in a direction towards the first device 1101, which receives and decodes the first data 1125. In some embodiments, the transmitter 1123 can be located on a fifth device 1122. The first data 1125 can contain navigation commands to move the under-water object in a desired direction using the propulsion and steering system.

The system shown in FIG. 11 can use a method comprising placing at least one object 1107, such as a probe, dropped from the water surface to a desired location at the water bottom. The object 1107 can include a plurality of components, such as a piece of equipment or sensor, an optional propulsion system or navigation module, and other components such as weights or anchors. Similarly, the system can include a plurality of devices, such as a first device 1101, second device 1111, third device 1113, forth device 1115, fifth device 1122 and at least one object 1107, wherein a propulsion system 1109 may be attached to the object 1107, or to the first device 1101. The first device 1101 can include a first acoustic transmitter 1103 and a first acoustic receiver 1105, wherein the first acoustic transmitter 1103 transmits a first acoustic wave 1130 in a direction or all directions, wherein the first acoustic wave 1130 is received by an acoustic receiver on another device, such as the receiver 1117 on the second device 1111, or the third acoustic receiver 1119 on the third device 1113, or the fourth acoustic receiver 1121 on the fourth device 1115, or each of the receivers 1117, 1119 and 1121, wherein a fifth device 1122 with a second transmitter 1123 can transmit a second acoustic wave 1125 in the direction of the object 1107, wherein the second acoustic 1125 wave is received by the first receiver 1105, wherein the second acoustic wave can contain first data. The first data can include various types of information, such as encoded navigation commands. The navigation commands can be communicated to the propulsion system 1109 to aid in guiding the object 1107 to a desired position. The amplitude or frequency spectrum or time distribution of both the first acoustic wave 1130 and second acoustic wave 1125 can be continuously adjusted to the position of the second device 1111, third device 1113, or fourth device 1115 relative to the object 1107.

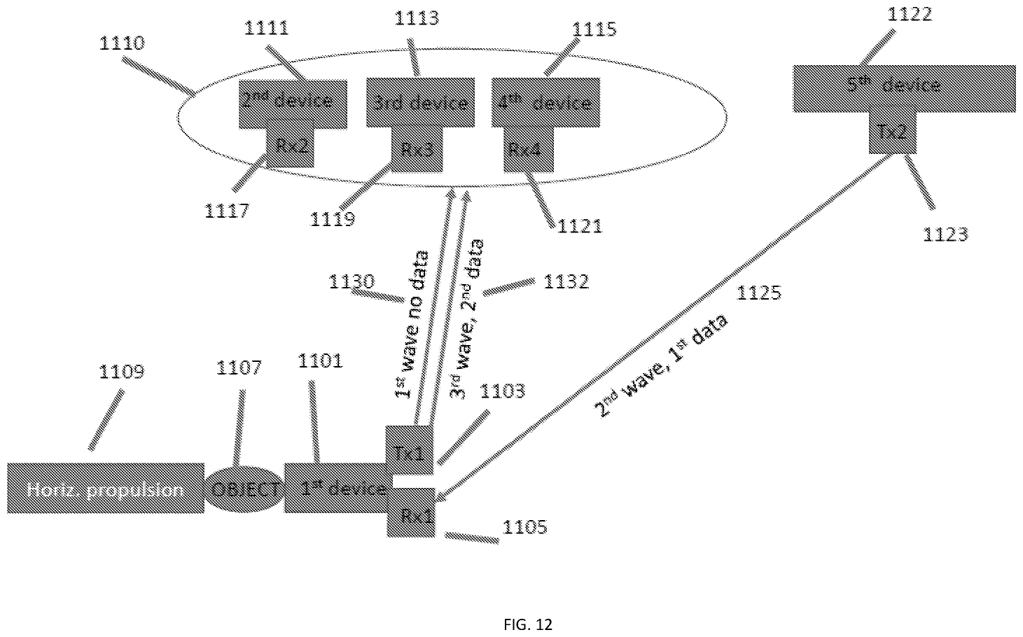

FIG. 12 shows an exemplary embodiment similar to that disclosed in FIG. 11, wherein the transmitter 1103 of a first device 1101 can transmit a third acoustic wave 1132, which can include a second data. The amplitude or frequency spectrum or time distribution of the third acoustic wave 1132 can be continuously adjusted to the position of the second device 1111, third device 1113, or fourth device 1115 relative to the object 1107. The third acoustic wave 1132 can be received by at least one receiver, as the receiver 1117 on the second device 1111, or the third acoustic receiver 1119 on the third device 1113, or the fourth acoustic receiver 1121 on the fourth device 1115. The second, or third or fourth device can then decode the second data incorporated in the third acoustic wave. The third wave 1132 can be transmitted from the remote transducer system of the first device 1101 through transmitter 1103 in a direction to the base transducer systems 1110. The third wave can encode a second data as digital information.

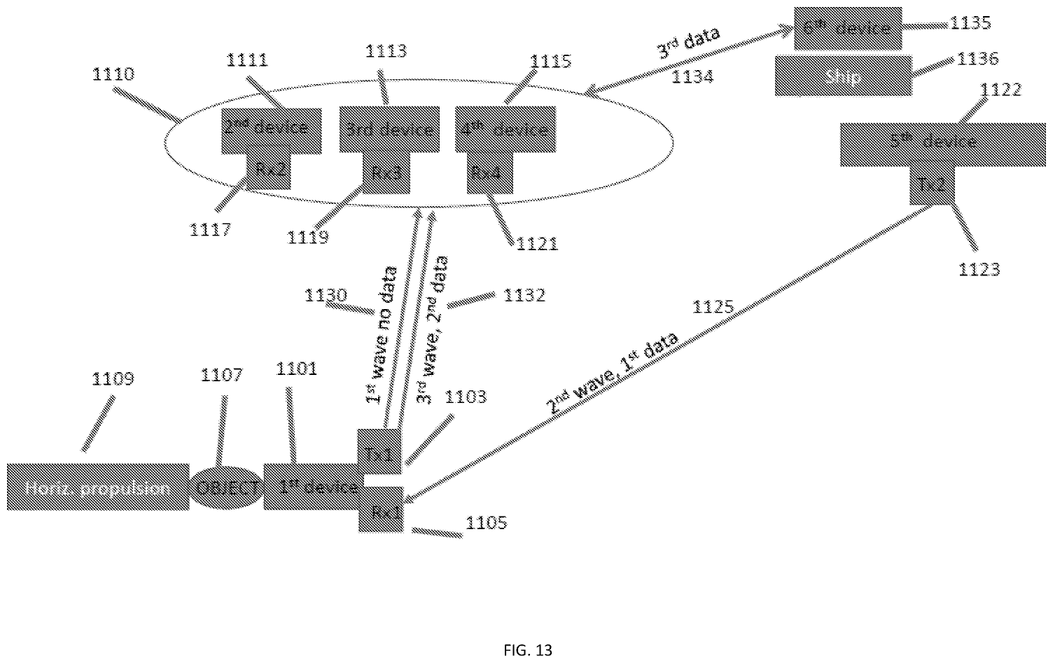

FIG. 13 shows an embodiment similar to the embodiment shown in FIG. 12, with the exception of including the exchange of signals and information denoted as third data 1134, which can be transmitted between the base transducer systems and a sixth device 1135, which in some exemplary embodiments may be located on a vessel 1136. In some exemplary embodiments, the sixth device can be a vessel communication system. A second or third or fourth device can transmit and receive the third data 1134 with a sixth device 1135, wherein the third data 1134 is transmitted and received via a wired link or a wireless link with the sixth device 1135. The sixth device 1135 can be located on a surface vessel, boat, or submarine, and can contain a processing unit, wherein the processing unit is capable of conducting display or storage or analysis of the third data 1135.

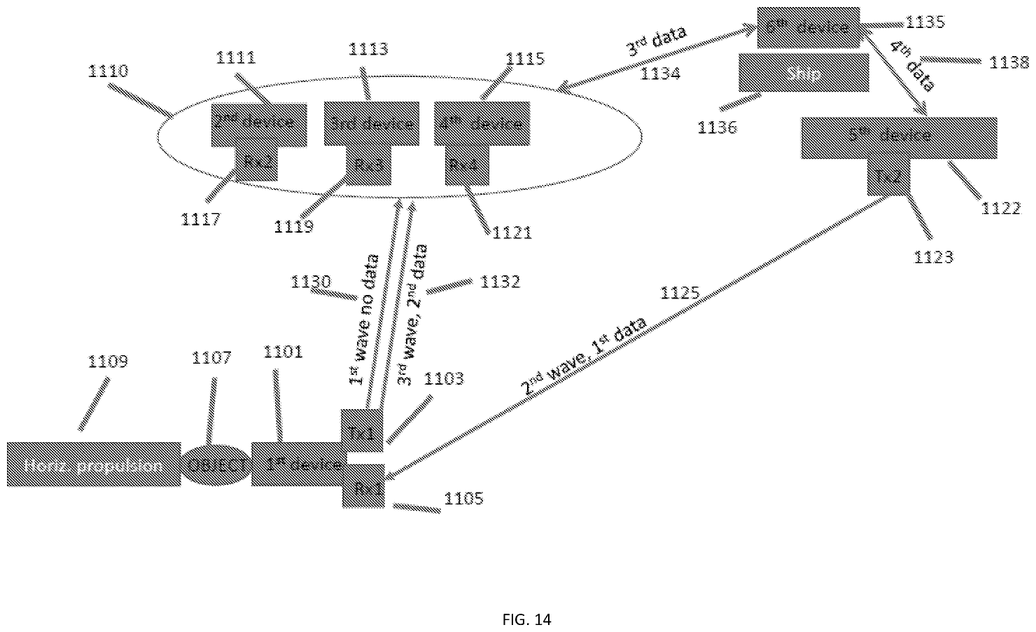

FIG. 14 shows an exemplary embodiment similar to the embodiment shown in FIG. 13, further including the exchange of signals and information, denoted as fourth data 1138, between the fifth device 1122 and the sixth device 1136. The sixth device 1136 can transmit and receive fourth data 1138 with the fifth device 1122. The sixth device 1136 can include a transmitter 1137 and receiver 1139. The fifth device 1122 can be located on or near the water surface, and connected by data link or mechanical connection or power line with a vessel 1136, such as a surface vessel or boat or submarine, and can convert the fourth data 1138 into the first data, wherein the first data are suitable for transmission through the second transmitter 1123 in a direction to the first device 1101.

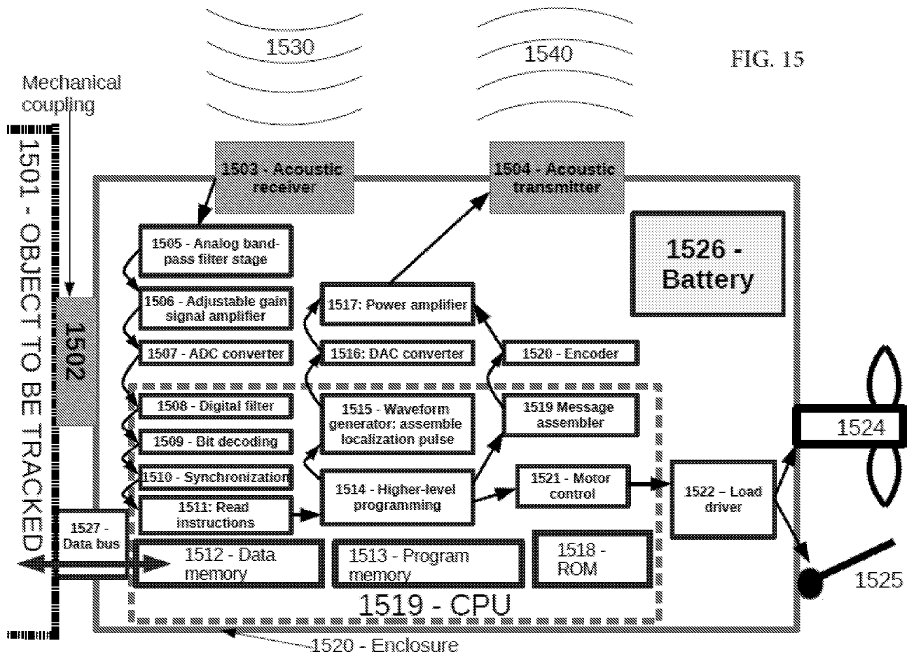

FIG. 15 is an illustration of an exemplary embodiment of a remote transducer system of the present disclosure, which can be located in a subsea proof enclosure 1520, which is attached to an object to be tracked 1501 through a mechanical coupling 1502. The system can include a power source 1526, such as a battery or other reservoir of stored energy or energy harvesting system, or combinations thereof, which power all the systems described. The system may also optionally contain, or be attached to, a propulsion system 1524 and/or rudder system 1525. The remote transducer system contains an acoustic receiver 1503 and an acoustic transmitter 1504, which may be integrated in the same transducer.

An incident acoustic wave 1530 can register in the acoustic receiver 1503, which can convert the wave to a time-dependent voltage signal. The electric signal can pass through an analog bandpass filter stage 1505, which removes any frequency components which are known not to be part of the desired signal transmitted from a base transducer system, resulting in second filtered signals. Second filtered signal can be passed through an adjustable gain amplifier stage 1506, which converts the second filtered signals in magnitude to a time-dependent voltage which can be conveniently measured by electronic measurement systems, resulting in a second amplified signal. The second amplified signal can be passed on to an analog-to-digital converter 1507, which can convert the second amplified signal into a digital signal representation.

An ADC converter 1507 can pass the digital representation of the signal to a CPU 1519. In some embodiments, the ADC converter 1507 is already integrated in the CPU 1519. Within the CPU, the digital representation of the signal is passed through a digital filter stage 1508, which performs other operations, such as anti-alias filtering or removing artifacts introduced by electronic systems such as the amplifier 1506, and which can produce a third filtered signal, which can be passed to a bit decoding system 1509, which can interpret the third filtered signal as sequences of binary data. The sequences of binary data may be passed to a synchronization system 1510, which can scan the bit sequence for the beginning of encoded commands in the bit system. The commands can be interpreted by a system 1511, which reads and interprets the instructions, and can pass the instructions on to a higher-level programming system 1514, which may be a set of hardware instructions, software programming, an operating system, algorithms, artificial intelligence, or a combination thereof.

The higher-level programming system 1514 may respond to instructions received from the system 1511, and may also have access to data memory 1512, program memory 1513 and ROM (read-only-memory) 1518. Data memory 1512 may be volatile memory, or non-volatile memory, or a combination of both. Data memory 1512 may receive information from the object 1501 through a data bus. A data bus may be through wired or wireless communication channels. Examples for wired channels can include Ethernet, USB, UART, SPI, I2C, or any proprietary system. Examples for wireless channels feasible in a subsea environment can include acoustic modems, low, or extremely low-frequency RF communications.

The higher-level programming unit 1514 may initiate instructions to a navigation module that can have propulsion system 1524 or a rudder system 1525 or instructions initiating the transmission of acoustic pulses through an acoustic transmitter 1504. The instructions may be issued based on instructions read from the incoming data through 1511, or they may be issued based on other events or schedules or other sensor data from within the remote transducer system or information received through the data bus 1527, determined by internal programming in the higher-level programming unit 1514.

The higher-level programming unit 1514 may initiate instructions to the propulsion system 1524 or the rudder system 1525. The instructions may be passed to a motor control unit 1521, which sends control signals to a load driver 1522, which may initiate electric motors or other electric actuators to drive an electric propulsion system or rudder system, which may be represented by 1524 and 1525.

Furthermore, the higher-level programming system 1514 may send instructions to a waveform generator 1515 to assemble a localization pulse, which may send data to a digital-to-analog converter 1516. The DAC converter 1516 may output the localization pulse as a time-dependent, low-power voltage signal versus time, and may pass the low-power voltage signal to a power amplifier 1517, which can excite an acoustic transmitter 1504, which can transmit a time-dependent acoustic waveform 1540 into the water, to be detected in multiple acoustic receivers in a base transducer system. In some exemplary embodiments of the invention, the DAC converter 1516 may be part of the CPU system 1519, whereas in other embodiments, the waveform generator 1515 may be outside the CPU system 1519.

Additionally, the higher-level programming system 1514 may instruct a message assembler 1519 to generate a message containing a system identifier of the specific remote transducer system, information from the data bus 1527, or other sensor or status data from within the enclosure 1520. The message assembler 1519 passes the messages to an encoder 1519, which converts the messages into low-power time-dependent voltage signals. The low-power voltage signals may be passed to a power amplifier, which can excite an acoustic transmitter 1504, which can transmit a time-dependent acoustic waveform 1540 into the water, to be detected in at least one acoustic receivers in a base transducer system. In some embodiments of the invention, the encoder 1520 may comprise part of the CPU system 1519.

The CPU 1519 may be any computer system able to execute a program and addressing memory, and may contain at least one, or a combination of multiple devices such as microcontrollers, DSPs, FPGAs, graphical processing units, or general-purpose processors such as used in personal computers. The CPU may also contain specialized integrated circuits, including but not limited to decode and/or encode and transmit information through a data bus interface. Any of the systems 1508, 1509, 1510, 1511, 1515, 1519 and 1521 may be such an integrated circuit, or a combination of multiple integrated circuits and other discrete electronic components comprising an electronic circuit.

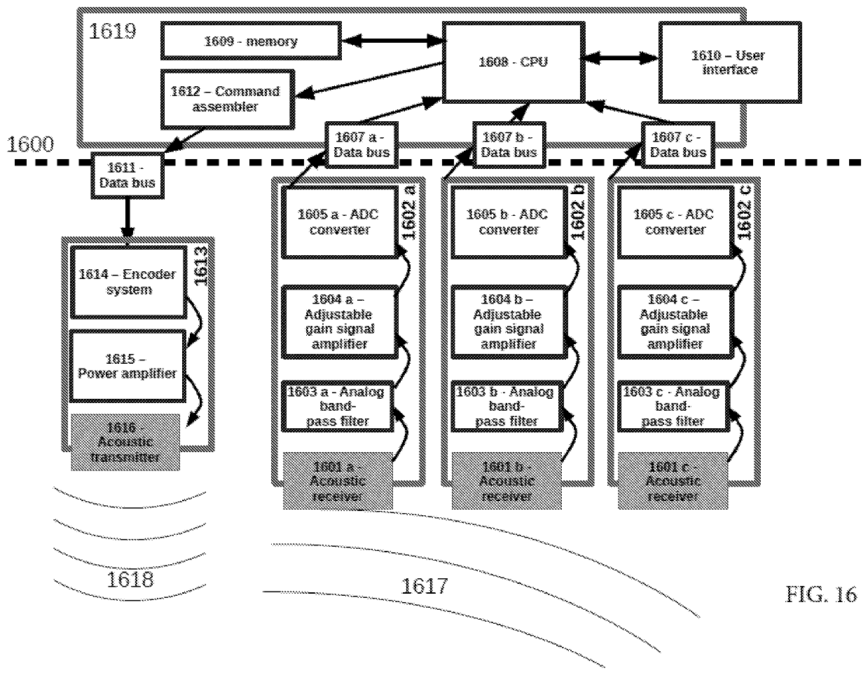

Similarly, FIG. 16 is an illustration of an exemplary embodiment of a base transducer system of the present disclosure, which in some embodiments can be located near the water surface 1600. The base transducer system can include one or more receivers. In one exemplary embodiment, the system can include at least three acoustic receivers 1601 a, 1601 b and 1601 c in water-proof enclosures 1602 a, 1602 b and 1602 c, partially or completely submerged under the water surface. An incident acoustic wave 1617 can register in the at least three acoustic receivers, which can then be converted it into electric signals. The electric signals can pass through analog bandpass filters 1603 a, 1603 b and 1603 c, located inside the water-proof enclosures. The bandpass filters can remove any frequency components which are known not to be part of the desired signal transmitted by a remote transducer system, resulting in first filtered signals. The first filtered signals are passed through adjustable gain amplifiers 1604 a, 1604 b and 1604 c, which convert the first filtered signals in magnitude to a voltage which can be conveniently measured by electronic measurement systems, resulting in a first amplified signal. The first amplified signals are passed on to analog-to-digital converters 1605 a, 1605 b and 1605 c, which convert the first amplified signals into digital signal representations.

It may not be known prior to receiving whether the incident wave 1617 contains a localization pulse or an encoded digital pulse, or a combination of both. Hence, the digital signal representations can be transmitted to a control system 1619 through data bus systems 1607 a, 1607 b and 1607 c. The data bus systems may be wired or wireless channels. Examples for wireless channels can include any short-range or long-range radio communications, including WiFi, cellular networks, ZigBee, Z-Wave or any proprietary RF protocol or any other suitable communication method. Similarly, examples for wired channels include Ethernet, USB, UART, SPI, I2C, or any proprietary system or other suitable system.

Digital signal representations may be received by a CPU 1608 in the control system 1619, which may perform additional digital filtering of the signal and determines whether the signal is a localization pulse or an encoded pulse. In the case of a localization pulse, the CPU 1608 may analyze the position of the remote transducer system based on the combination of digital representations of the pulses received by the acoustic receivers 1601 a, 1601 b and 1601 c. In the case of an encoded pulse, it may decode and analyze the information encoded from at least one of the acoustic receivers 1601 a, 1601 b and 1601 c. The CPU 1608 may store the digital signal representations, or information obtained through higher-level processing, onto memory 1609. The CPU 1608 may also, through a user interface 1610, communicate to a human user information such as the position of at least one remote transducer system, or other information, such as an identifier, sensor information or the status of a remote transducer system or an object it is tasked to track. The communication may be communicated to a user through displaying graphics, or text, or numbers, through any systems known in the art, such as graphics displays. The CPU 1608 may also, through the user interface 1610, solicit input from a human user, for example through a graphical user interface or a text-based user interface. The input may include or initiate commands transmitted to a remote transducer system, such as navigation commands. Such input may be accomplished by any number of systems, including at least one touch screen, mouse, keyboard or any other data input system known in the art.

The CPU 1608 may be any computer system able to execute a program and addressing memory, and may contain at least one, or a combination of multiple devices such as microcontrollers, DSPs, FPGAs, graphical processing units, or general-purpose processors such as used in personal computers. The CPU may also contain specialized integrated circuits, including but not limited to decode and/or encode and transmit information through a data bus interface or through a user interface, or controlling non-volatile memory 1609. In some embodiments, any of the ADC converters 1605 a/b/c, adjustable gain amplifiers 1604 a/b/c or analog bandpass filters 1603 a/b/c may be located inside the control system 1619 and be integrated, or directly connected with, the CPU 1608.

Additionally, the CPU 1608 may instruct a command assembler 1612 to initiate transmission of a command through a data bus 1611 to an encoder system 1614. In some embodiments, the command assembler 1612 may comprise part of the CPU 1608. The data bus 1611 may be any wired or wireless system, in the same manner as in data bus 1607 a, b, c. The encoder system 1614 is located inside a water-tight enclosure 1613, which may be partially or completely submerged. The encoder system converts the digital representation of a command to be transmitted into a time-dependent voltage signal. The time-dependent voltage signal may be passed to a power amplifier 1615, which excites an acoustic transmitter 1616, which can transmit a time-dependent acoustic waveform into the water, to be detected in at least one remote transducer system.

In some embodiments of the invention, any of the encoder system 1614 or power amplifier 1615 may comprise part of the control system 1619, and the encoder system 1614 may be part of, or be directly connected to, CPU 1608. Similarly, in some exemplary embodiments, the acoustic transmitter 1616 may be located inside the same enclosure as any of the receivers 1601 a, b, c. In a subset of such embodiments, the acoustic transmitter 1616 may comprise the same transducer as one of the receivers 1601 a, b, c.

An underwater remote locator device for tracking and positioning an object of the present disclosure can include a remote transducer system, a base transducer system, and a navigation module. The remote transducer system can be coupled to an object desired to be tracked. The remote transducer system can include a power source, processing means, acoustic receiver, and an acoustic transmitter. The acoustic transmitter can be configured to transmit a first acoustic wave in one or more directions. The base transducer system can include a processing means, a first base transducer having a first acoustic receiver, a second base transducer having a second acoustic receiver, and a third base transducer having a third acoustic receiver. Each acoustic receiver can be configured to receive said first acoustic wave from the remote transducer system.

In some exemplary embodiments, one or more of the base transducers can further include an acoustic transmitter that can be configured to transmit a second acoustic wave in the direction of said object. The navigation module coupled to the object or remote transducer system. The navigation module can include a propulsion system and a steering system. The navigation module can be communicatively coupled to the remote transducer system. The remote transducer system can be configured to receive the second acoustic wave. The second acoustic wave can contain a first data set. In some exemplary embodiments, the first data set can be encoded navigation commands to be executed by said processing means of the remote transducer system and initiate one or more actions by the propulsion system and steering system. Similarly, the navigation module can be couple to the remote transducer system, or alternatively directly to the object to be tracked. The navigation module comprises a transducer and said rudder system and said propulsion system are oriented in two directions in the plane substantially perpendicular to the direction of gravity.

A first acoustic wave can be transmitted in one or more directions using said acoustic transmitter. The first acoustic wave can be received by the first acoustic receiver of the base transducer system. A second acoustic wave can be transmitted in the direction of said base transducer system by the remote transducer system. The second acoustic wave can be received by the receiver of the base transducer system. The second acoustic wave contains first data set.

In one exemplary embodiment, a first receiver can be positioned in a first location at a first pre-select time, a second location at a second pre-select time, and a third location at a third preselect time. Each location can be different from the other. In some exemplary embodiments, the locations will form a geometric shape and not exist in a straight line. The first receiver can be configured to receive said first acoustic waves in each of the first, second, and third locations, at the corresponding times.

The remote transducer system can be configured to be coupled to an object. The first data set can contain navigation commands based on the present position of the object as determined from said first acoustic wave compared with a preselected target position. The first acoustic wave can be repeated and said navigation commands can be updated and retransmitted until said object has landed on said preselected target position using a control algorithm. The base transducer system can transmit and receive a third data set from a vessel communication system. The third data set can be sent to and from the vessel communication system. The vessel communication system can include a processing unit, receiver, and transmitter, wherein said processing unit is capable of displaying, storing, or analysis of said third data set.

The present disclosure can also provide method to place at least one object dropped from the water surface to a desired location at the water bottom. A first device, second device, third device, forth device, fifth device and at least one object to be tracked can be provided. The first device can include a first acoustic transmitter and a first acoustic receiver, wherein the first device can be coupled to said object. The object to be tracked can include one or more geophysical notes, such as such as ocean-bottom seismic nodes, electromagnetic nodes, or collection devices. The electromagnetic nodes can collect data for controlled-source electromagnetic or magnetotelluric surveys and the collection devices take soil samples for immediate or later chemical analysis.

A propulsion system coupled directly to said object or to said first device can be provided. A first acoustic can be transmitted wave in one or more directions using said first acoustic transmitter. The first acoustic wave can be received by a second acoustic receiver on a second device, a third acoustic receiver on a third device, and a fourth acoustic receiver on a said fourth device. A second acoustic wave can be transmitted in the direction of said object by a second transmitter of the fifth device. The second acoustic wave can be received by the first receiver, wherein the second acoustic wave contains first data set. The first data set can include encoded navigation commands.

The first acoustic wave and second acoustic wave can each have an amplitude, frequency distribution, or time distribution. Each amplitude, frequency distribution, or time distribution of said first acoustic wave or said second acoustic wave can be continuously adjusted depending on various factors. The conditions can include but are not limited to the depth of said first device under the water, environmental conditions, density of said water, water layers of different temperatures, pollution of said water, or the distance of said first device to any combination of said second or third or fourth device.

Additionally, the first acoustic wave receive by the one or devices, such as a transducers or the second, third, and fourth device, can be a wave packet with a time dependence and frequency distribution. The wave packet can be converted into electronic signals by the second, or third or fourth device. The signals or times at which the signals are received by each of said second device, third device and fourth device can be used to determine the spatial position of said first device based on the difference of one or more phases, wave form shapes, or combination phases and wave from shapes of one or more of said signals received by each of said second device, third device, and fourth device.

The transmitter of the first device can transmit a third acoustic wave that can have an amplitude, frequency spectrum, or time distribution that can be continuously adjusted to the position of said second device, third device, or fourth device. A second data set can be incorporated in said third acoustic wave, which can be received by the second receiver on the second device, third receiver on the third device, or the fourth receiver on the fourth device. The second, or third or fourth device can decode the second data set incorporated in said third acoustic wave.

Additionally, in one exemplary embodiment, the second or third or fourth device can transmit and receive a third data set with a sixth device. The third data set can be exchanged with the sixth device. The sixth device can include a processing unit and is located on a vessel. The processing unit is capable of conducting display or storage or analysis of said third data set.

The sixth device can transmit and receive a fourth data set with the fifth device. The fifth device can be located proximate to the water surface and communicatively coupled to said vessel. The fifth device can convert the fourth data set into said first data set. The first data set can be suitable for transmission through said second transmitter in a direction to said first device. The first data set can contain navigation commands based on the present position of the object as determined from the first acoustic wave compared with a desired target position. The first acoustic wave can be repeated and said navigation commands can be updated and retransmitted until said object has landed on said target position using a control algorithm.

A plurality of objects can be deployed simultaneously and the second, third and fourth devices can receive at least the first acoustic wave and at least the third acoustic wave with encoded unique identifier for each of said objects. A fifth device can transmit navigation commands to different objects by encoding said unique identifier in said second acoustic wave, thus controlling multiple said objects simultaneously.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

1. A method to place at least one object dropped from the water surface to a desired location at the water bottom, wherein said method comprises:
providing a first device, second device, third device, forth device, fifth device and at least one object to be tracked, wherein the first device can include a first acoustic transmitter and a first acoustic receiver, wherein said first device is coupled to said object;
providing a propulsion system coupled directly to said object or to said first device;
transmitting a first acoustic wave in one or more directions using said first acoustic transmitter;
receiving said first acoustic wave by a second acoustic receiver on said second device, a third acoustic receiver on said third device, and a fourth acoustic receiver on said fourth device;
transmitting a second acoustic wave in the direction of said object by a second transmitter of the fifth device;
receiving said second acoustic wave by said first receiver, wherein the second acoustic wave contains first data set, wherein said first data set is encoded navigation commands.

2. The method of claim 1, wherein the object to be tracked can include one or more geophysical nodes, such as ocean-bottom seismic nodes, electromagnetic nodes, or collection devices, wherein said electromagnetic nodes collect data for controlled-source electromagnetic or magnetotelluric surveys, wherein said collection devices take soil samples for immediate or later chemical analysis.

3. The method of claim 1, wherein the first acoustic wave and second acoustic wave can each have an amplitude, frequency distribution, or time distribution;
wherein each amplitude, frequency distribution, or time distribution of said first acoustic wave or said second acoustic wave are continuously adjusted depending on one or more of the following:
the depth of said first device under the water,
environmental conditions,
density of said water,
water layers of different temperatures,
pollution of said water, or
the distance of said first device to any combination of said second or third or fourth device.

4. The method in claim 1, wherein said first acoustic wave received by said second device, third device, and fourth device is a wave packet with a time dependence and frequency distribution, wherein said wave packet is further converted into electronic signals by said second, or third or fourth device;
wherein said signals or times at which the signals are received by each of said second device, third device and fourth device are used to determine the spatial position of said first device based on the difference of one or more phases, wave form shapes, or combination phases and wave from shapes of one or more of said signals received by each of said second device, third device, and fourth device.

5. The method in claim 4, wherein said transmitter of said first device transmits a third acoustic wave, wherein the amplitude, frequency spectrum, or time distribution of said third acoustic wave are continuously adjusted to the position of said second device, third device, or fourth device, wherein a second data set is incorporated in said third acoustic wave, wherein the third acoustic wave is received by the second receiver on the second device, third receiver on the third device, or the fourth receiver on the fourth device, wherein the second, or third or fourth device decodes the second data set incorporated in said third acoustic wave.

6. The method in claim 5, wherein the second data set contains information of said first devices, wherein said information can comprise unique identifier data of first device, status of the first device, or data relayed from said object.

7. The method in claim 1, wherein the second or third or fourth device transmits and receives a third data set with a sixth device, wherein the third data set is exchanged with the sixth device, wherein said sixth device comprises a processing unit and is located on a vessel, wherein said processing unit is capable of conducting display or storage or analysis of said third data set.

8. The method in claim 7, wherein said sixth device transmits and receives a fourth data set with the fifth device, wherein the fifth device is located proximate to the water surface and communicatively coupled to said vessel, wherein said fifth device converts the fourth data set into said first data set, wherein said first data set are suitable for transmission through said second transmitter in a direction to said first device.

9. The method in claim 8, wherein said first data set contains navigation commands based on the present position of said object as determined from said first acoustic wave compared with a desired target position, wherein said first acoustic wave is repeated and said navigation commands are updated and retransmitted until said object has landed on said target position using a control algorithm.

10. The method in claim 7, wherein a plurality of objects are deployed simultaneously, wherein said second and third and fourth devices receive at least the first acoustic wave and at least the third acoustic wave with encoded unique identifier for each of said objects, wherein said fifth device transmits navigation commands to different objects by encoding said unique identifier in said second acoustic wave, thus controlling multiple said objects simultaneously.

11. An underwater communication and positioning system for a remote locator device, the system comprising:
a base transducer system, comprising:
a processing means;
a first base transducer having a first acoustic receiver; and
a remote transducer system, comprising:
a power source,
a processing means,
an acoustic receiver, and
an acoustic transmitter, wherein said acoustic transmitter is configured to transmit an acoustic wave.

12. The system of claim 11, wherein the base transducer system further comprises a second base transducer having a second acoustic receiver and a third base transducer having a third acoustic receiver, wherein each acoustic receiver is configured to receive an acoustic wave from the remote transducer system.

13. The system of claim 11, wherein a first acoustic wave is transmitted in one or more directions using said acoustic transmitter;
wherein said first acoustic wave is received by the first acoustic receiver of the base transducer system;
wherein a second acoustic wave is transmitted in the direction of said base transducer system by the remote transducer system;
wherein said second acoustic wave is received by the receiver of the base transducer system, wherein the second acoustic wave contains first data set.

14. The system of claim 13, wherein the first receiver can be positioned in a first location at a first pre-select time, a second location at a second pre-select time, and a third location at a third preselect time, wherein each location is different from the other, wherein the first receiver is configured to receive said first acoustic waves in each of the first, second, and third locations, at the corresponding times.

15. The system of claim 11, further comprising a navigation module comprising a propulsion system and a rudder system, wherein the navigation module can be coupled to the remote transducer system.

16. The system of claim 11 wherein said first acoustic receiver, second acoustic receiver, and third acoustic receiver of the base transducer system are connected by rigid struts, wherein said rigid struts comprise a rigid structure.

17. The system of claim 15, wherein said navigation module comprises a transducer and said rudder system and said propulsion system are oriented in two directions in the plane substantially perpendicular to the direction of gravity.

18. The system of claim 13, wherein said remote transducer system is configured to be coupled to an object, wherein said first data set contains navigation commands based on the present position of said object as determined from said first acoustic wave compared with a preselected target position, wherein said first acoustic wave is repeated and said navigation commands are updated and retransmitted until said object has landed on said preselected target position using a control algorithm.

19. The system of claim 18, wherein the base transducer system transmits and receives a third data set from a vessel communication system, wherein the third data set is sent to and from the vessel communication system, wherein said vessel communication system comprises a processing unit, receiver, and transmitter, wherein said processing unit is capable of displaying, storing, or analysis of said third data set.

20. An underwater remote locator device for tracking and position an object, the system comprising:
a remote transducer system coupled to said object, wherein said remote transducer system, comprises:
a power source,
a processing means,
an acoustic receiver, and
an acoustic transmitter, wherein said acoustic transmitter is configured to transmit a first acoustic wave in one or more directions;
a base transducer system, comprising:
a processing means;
a first base transducer having a first acoustic receiver;
a second base transducer having a second acoustic receiver; and
a third base transducer having a third acoustic receiver,
wherein each acoustic receiver is configured to receive said first acoustic wave from the remote transducer system, wherein one or more of the base transducers further comprises an acoustic transmitter configured to transmit a second acoustic wave in the direction of said object; and
a navigation module coupled to the object or remote transducer system, wherein the navigation module comprise a propulsion system and a steering system, wherein said navigation module is communicatively coupled to said remote transducer system, wherein said remote transducer system is configured to receive said second acoustic wave, wherein said second acoustic wave contains a first data set, wherein said first data set is encoded navigation commands to be executed by said processing means of the remote transducer system and initiate one or more actions by the propulsion system and steering system.
